(19) United States
(12) Patent Application Publication
(10) Pub. No.: US 2026/0101842 A1
(43) Pub. Date: Apr. 16, 2026

(54) Powered Cutting Head Load System and Method

(71) Applicant: Deere & Company, Moline, IL (US)

(72) Inventors: Scott N. Clark, Bettendorf, IA (US); Jason E. Haubenstricker, Davenport, IA (US); Nathan R. Vandike, Geneseo, IL (US)

(21) Appl. No.: 18/911,953

(22) Filed: Oct. 10, 2024

(51) Int. Cl. A01D 41/127; A01D 41/14; A01D 69/02

(52) U.S. Cl. CPC A01D 41/1274; A01D 41/142; A01D 69/02

(57) ABSTRACT

An agricultural machine for harvesting crop includes a cutting head, a propulsion system, and a controller. The cutting head harvests crop and conduct harvested crop to a work machine configured to process harvested crop. The cutting head includes one or more ground engaging mechanisms that rotate to propel the cutting head along a ground surface. The propulsion system provides power to the one or more ground engaging mechanisms to drive rotation thereof. The controller receives one or more first signals and sends at least one additional signal based on receipt of the one or more first signals. The at least one additional signal causes redistribution of a load on the cutting head.

### FIELD OF THE DISCLOSURE

The present description relates to agricultural machines and, in particular, to systems and methods associated with a cutting head of an agricultural machine.

### BACKGROUND OF THE DISCLOSURE

There are a variety of different types of agricultural machines. Some agricultural machines include work machines such as combines, sugar cane harvesters, cotton harvesters, self-propelled forage harvesters, and windrowers, each of which process harvested crop that is harvested by a cutting head. These agricultural machines may include control systems configured to control the cutting head, the work machine, or both. Features associated with the cutting head, the control system, and the work machine may improve operation of the agricultural machine.

### SUMMARY

In an illustrative implementation, an agricultural machine for harvesting crop, comprises a cutting head configured to harvest crop and conduct harvested crop to a work machine configured to process harvested crop. The cutting head includes one or more ground engaging mechanisms configured to rotate to propel the cutting head along a ground surface. The agricultural machine further comprises a propulsion system configured to provide power to the one or more ground engaging mechanisms to drive rotation thereof.

In some implementations, the propulsion system includes an electric motor located on the cutting head and configured to provide power to the one or more ground engaging mechanisms to drive rotation thereof. In some implementations, the propulsion system comprises a battery coupled to the electric motor. In some implementations, the propulsion system comprises a generator coupled to the electric motor.

In some implementations, the propulsion system comprises: a hydraulic pump located on the work machine; and a motor coupled to the hydraulic pump and located on the cutting head. The motor is configured to provide power to the one or more ground engaging mechanisms to drive rotation thereof.

In some implementations, the propulsion system comprises a motor configured to provide power to the one or more ground engaging mechanisms; and the motor is configured to generate energy.

In some implementations, the one or more ground engaging mechanisms of the cutting head includes a first ground engaging mechanism and a second ground engaging mechanism; and the propulsion system includes a first motor configured to provide power to the first ground engaging mechanism and a second motor configured to provide power to the second ground engaging mechanism.

In some implementations, the agricultural machine comprises the work machine; the work machine includes a plurality of subsystems configured to process harvested crop; and the agricultural machine includes a prime mover located on the work machine and configured to power the plurality of subsystems and the propulsion system.

In some implementations, the propulsion system is located partially on the cutting head and partially on the work machine. In some implementations, the propulsion system is located entirely on the cutting head.

In some implementations, the propulsion system includes a motor configured to rotate about a drive axis to provide power to a first ground engaging mechanism of the one or more ground engaging mechanisms; the first ground engaging mechanism rotates about a driven axis; and the drive axis and the driven axis are aligned.

In some implementations, the propulsion system includes a motor configured to rotate about a drive axis to provide power to a first ground engaging mechanism of the one or more ground engaging mechanisms. The first ground engaging mechanism rotates about a driven axis; and the drive axis and the driven axis are not aligned.

In some implementations, the agricultural machine further comprises a controller configured to adjust the power provided to the one or more ground engaging mechanisms of the cutting head.

In some implementations, the agricultural machine further comprises a user interface operatively coupled to the controller and configured to receive input from a user; the controller is configured to adjust the power provided to the one or more ground engaging mechanisms of the cutting head based on at least one signal received from the user interface indicative of the input from the user.

In some implementations, the agricultural machine further comprises at least one sensor operatively coupled to the controller and configured to measure a work site characteristic including at least one of soil condition of the work site and terrain of the work site; the controller is configured to adjust the power provided to the one or more ground engaging mechanisms of the cutting head based on at least one signal received from the at least one sensor indicative of at least one work site characteristic.

In some implementations, the agricultural machine further comprises the cutting head including a brake that, when engaged, causes rotation of the ground engaging mechanisms to cease or slow. In some implementations, the agricultural machine further comprises the work machine. In such implementations, the work machine is a combine configured to thresh harvested crop received from the cutting head.

In some implementations, the agricultural machine further comprises the work machine; and the cutting head is coupled to the work machine.

In some implementations, the propulsion system is configured to provide power to the one or more ground engaging mechanisms to drive rotation of the one or more ground engaging mechanisms while the cutting head is harvesting crop.

In another illustrative implementation, an agricultural machine for harvesting crop, comprises: a cutting head configured to harvest crop and conduct the harvested crop to a work machine including one or more subsystems configured to process harvested crop, the cutting head including one or more ground engaging mechanisms configured to rotate to propel the cutting head along a ground surface. The one or more ground engaging mechanisms is configured to receive power from a prime mover that is also configured to provide power to the one or more subsystems of the work machine

In another illustrative implementation, an agricultural machine for harvesting crop, comprises: a cutting head configured to harvest crop and conduct the harvested crop to a work machine configured to process harvested crop, the cutting head including one or more ground engaging mechanisms configured to rotate to propel the cutting head along a ground surface. The agricultural machine further comprises: a propulsion system configured to receive power from a prime mover of the work machine and provide power to the one or more ground engaging mechanisms to drive rotation thereof.

In some implementations, the propulsion system comprises a battery rechargeable by the prime mover and an electric motor coupled to the battery; the electric motor is located on the cutting head and configured to provide power to the one or more ground engaging mechanisms to drive rotation thereof.

In another illustrative implementation, a method of propelling a cutting head configured to harvest crop comprises: providing power, via a propulsion system, to one or more ground engaging mechanisms of the cutting head to drive rotation of the one or more ground engaging mechanisms and propel the cutting head along a ground surface; and adjusting, via a controller, the power provided by the propulsion system to the one or more ground engaging mechanisms of the cutting head.

In an illustrative implementation, an agricultural machine for harvesting crop comprises: a cutting head configured to harvest crop and conduct harvested crop to a work machine configured to process harvested crop. The cutting head includes: (i) one or more ground engaging mechanisms configured to rotate to propel the cutting head along a ground surface, and (ii) a propulsion system configured to provide power to the one or more ground engaging mechanisms to drive rotation thereof. The agricultural machine further includes a controller configured to receive one or more first signals and send at least one additional signal based on receipt of the one or more first signals. In a first configuration of the agricultural machine, the cutting head is spaced apart from the work machine and, in a second configuration of the agricultural machine, the cutting head is coupled to the work machine. The at least one additional signal causes or enables action of the cutting head associated with coupling the cutting head to the work machine.

In some implementations, the at least one additional signal switches the propulsion system between a first mode in which the propulsion system provides no power to the one or more ground engaging mechanisms and a second mode in which the propulsion system provides power to the one or more ground engaging mechanisms. In some implementations, the one or more ground engaging mechanisms of the cutting head includes a first ground engaging mechanism and a second ground engaging mechanism; and the propulsion system includes a first motor configured to provide power to the first ground engaging mechanism and a second motor configured to provide power to the second ground engaging mechanism.

In some implementations, in response to receipt of the at least one additional signal, the propulsion system provides power to the one or more ground engaging mechanisms at a designated torque or change in torque. In some implementations, in response to receipt of the at least one additional signal, the propulsion system provides power to the one or more ground engaging mechanisms at a designated speed or change in speed.

In some implementations, the agricultural machine further comprises one or more actuators coupled to the one or more ground engaging mechanisms; and the one or more actuators are configured to receive the at least one additional signal from the controller and pivot the one or more the ground engaging mechanisms based on the at least one additional signal.

In some implementations, the agricultural machine further comprises a user interface operatively coupled to the controller; and the user interface provides the one or more first signals to the controller. In some implementations, the one or more first signals is associated with a location to which the cutting head is directed to move. In some implementations, the one or more first signals is associated with one or more directions of movement for the cutting head. In some implementations, the one or more directions of movement includes at least one of a forward direction of movement and a rearward direction of movement relative to the work machine and a right direction of movement and left direction of movement relative to the work machine. In some implementations, the one or more directions of movement includes at least one of rotation clockwise and rotation counterclockwise. In some implementations, the user interface is located on the work machine.

In some implementations, the one or more first signals is transmitted wirelessly to the controller. In some implementations, the one or more first signals signal is based on at least one of a location of the work machine and an orientation of the work machine.

In some implementations, the agricultural machine further comprises the work machine; and the work machine is a combine configured to thresh harvested crop received from the cutting head.

In another illustrative implementation, an agricultural machine for harvesting crop, comprises: a work machine including at least one subsystem configured to process harvested crop; a cutting head configured to harvest crop and conduct harvested crop to the combine, the cutting head including: (i) one or more ground engaging mechanisms configured to rotate to propel the cutting head along a ground surface, and (ii) a propulsion system configured to provide power to the one or more ground engaging mechanisms to drive rotation thereof; wherein the cutting head is configured to receive at least one signal associated with coupling the cutting head to the work machine. In a first configuration of the agricultural machine, the cutting head is spaced apart from the work machine and, in a second configuration of the agricultural machine, the cutting head is coupled to the work machine. In some implementations, the cutting head further comprises one or more actuators coupled to the one or more ground engaging mechanisms; and the one or more actuators are configured to pivot the one or more the ground engaging mechanisms.

In another illustrative implementation, a method of propelling a cutting head that harvests crop and conducts the harvested crop to a work machine configured to process harvested crop includes: receiving, via a controller, one or more first signals; and sending, via the controller, at least one additional signal to the cutting head based on the one or more first signals. The at least one additional signal causes at least one of: (i) a propulsion system of the cutting head to adjust the power provided to one or more ground engaging mechanisms of the cutting head that propel the cutting head along a ground surface, and (ii) one or more actuators to pivot the one or more the ground engaging mechanisms. The method further includes coupling the cutting head to the work machine in response to receipt by the cutting head of the at least one additional signal.

In some implementations, the one or more first signals is based on at least one of a location of the work machine and an orientation of the work machine. In some implementations, the method further includes sending the one or more first signals from a user interface to the controller.

In an illustrative implementation, an agricultural machine for harvesting crop, comprises: a cutting head configured to harvest crop and conduct harvested crop to a work machine configured to process harvested crop. The cutting head includes one or more ground engaging mechanisms configured to rotate to propel the cutting head along a ground surface. The agricultural machine further comprises: a propulsion system configured to provide power to the one or more ground engaging mechanisms to drive rotation thereof; and a controller configured to receive one or more first signals and send at least one additional signal based on receipt of the one or more first signals. The at least one additional signal causes redistribution of a load on the cutting head.

In some implementations, the one or more additional signals further causes adjustment of the power provided by the propulsion system to the one or more ground engaging mechanisms.

In some implementations, the agricultural machine further comprising one or more actuators that are operatively coupled to the controller and configured to extend or retract based on the at least one additional signal to redistribute the load on the cutting head. In some implementations, the at least one additional signal is a command from the user interface to adjust a pressure within at least one actuator of the one or more actuators. In some implementations, the at least one additional signal is a command from the user interface to adjust a position of the cutting head or a portion thereof. In some implementations, the work machine further comprises a feederhouse coupled to and configured to receive harvested crop from the cutting head; and the one or more actuators are configured to move the feederhouse based on the at least one additional signal.

In some implementations, the cutting head includes: (i) an attachment frame and (ii) a body frame to which the one or more ground engaging mechanisms are coupled; and the one or more actuators is configured to extend and retract to move the body frame relative to the attachment frame based on the at least one additional signal. In some implementations, the cutting head includes a center frame and first wing coupled to a first side of the center frame; and the one or more actuators is configured to extend and retract to move the first wing relative to the center frame based on the at least one additional signal. In some implementations, the cutting head further includes a body section coupled to the one or more ground engaging mechanisms; the body section is configured conduct harvested crop to the work machine; and the one or more actuators is configured to extend and retract to move the body section relative to the one or more ground engaging mechanisms based on the at least one additional signal.

In some implementations, the one or more first signals is indicative of a load on the cutting head. In some implementations, the one or more first signals is indicative of a load on the work machine. In some implementations, the one or more first signals is indicative of a load on at least one of: the cutting head at a specified location on the cutting head; and the work machine at a specified location on the work machine. In some implementations, the one or more first signals is indicative of a future load on at least one of the cutting head and the work machine.

In some implementations, the one or more first signals is associated with a soil condition of a work site of the agricultural machine; and the soil condition of the worksite includes at least one of soil moisture, soil type, soil firmness, and soil adhesion. In some implementations, the one or more first signals is associated with a terrain of a work site of the agricultural machine; and the terrain of the worksite includes at least one of pitch and roll of the worksite.

In some implementations, the agricultural machine further comprises the work machine; and the work machine is a combine configured to thresh harvested crop received from the cutting head.

In some implementations, the one or more first signals is indicative of at least one of: slip of one or more ground engaging mechanisms of the cutting head; and slip of one or more work machine ground engaging mechanisms. In some implementations, the one or more first signals is associated with at least one of: a speed of the work machine, a speed of the cutting head, a speed of one or more work machine ground engaging mechanisms, and a speed of the one or more ground engaging mechanisms of the cutting head.

In another illustrative implementation, an agricultural machine for harvesting crop, comprises: a cutting head configured to harvest crop and conduct harvested crop to a work machine configured to process harvested crop. The cutting head includes one or more ground engaging mechanisms configured to rotate to propel the cutting head along a ground surface. The agricultural machine further comprises, one or more actuators configured to redistribute a load on the cutting head; and a propulsion system configured to adjust power provided to the one or more ground engaging mechanisms based on redistribution of load on the cutting head.

In another illustrative implementation, a method of propelling a cutting head for harvesting crop, comprises: providing power, via a propulsion system, to one or more ground engaging mechanisms of the cutting head to drive rotation of the one or more ground engaging mechanisms and propel the cutting head along a ground surface; receiving one or more first signals via a controller; and sending at least one additional signal, via the controller, to one or more actuators based on receipt of the one or more first signals, wherein the at least one additional signal causes redistribution of load on the cutting head.

In an illustrative implementation, an agricultural machine for harvesting crop, comprises: a cutting head configured to harvest crop and conduct harvested crop to a work machine configured to process harvested crop. The cutting head including one or more ground engaging mechanisms configured to rotate to propel the cutting head along a ground surface. The agricultural machine further comprises: a propulsion system configured to provide power to the one or more ground engaging mechanisms to drive rotation thereof; and a controller configured to receive one or more first signals and send at least one additional signal based on receipt of the one or more first signals. The at least one additional signal causes pivoting movement of the one or more ground engaging mechanisms.

In some implementations, the agricultural machine further comprises one or more actuators configured to receive the at least one additional signal from the controller and pivot the one or more the ground engaging mechanisms based on the at least one additional signal.

In some implementations, in response to receipt of the at least one additional signal, the propulsion system provides power to the one or more ground engaging mechanisms at a designated torque or change in torque. In some implementations, in response to receipt of the at least one additional signal, the propulsion system provides power to the one or more ground engaging mechanisms at a designated speed or change in speed.

In some implementations, the one or more first signals is associated with a steering characteristic of the work machine. In some implementations, the agricultural machine further comprises: the work machine, including one or more work machine ground engaging mechanisms configured to propel the work machine along the ground surface; and a user interface operatively coupled to the controller and including a steering device configured to direct pivoting movement of the one or more work machine ground engaging mechanisms; the one or more first signals is associated with the position of the steering device; and the position of the steering device is a steering characteristic of the work machine.

In some implementations, the agricultural machine further comprises: the work machine, including one or more work machine ground engaging mechanisms configured to propel the work machine along the ground surface; and at least one angle sensor configured to measure a parameter indicative of the angle of one or more work machine ground engaging mechanisms; the one or more first signals is associated with the angle of the one or more work machine ground engaging mechanisms; and the angle of the one or more work machine ground engaging mechanisms is a steering characteristic of the work machine. In some implementations, the agricultural machine further comprises: the one or more first signals is associated with a future travel path of the work machine.

In some implementations, the one or more first signals is associated with terrain of a work site of the agricultural machine; and the terrain of the worksite includes at least one of pitch and roll of the worksite. In some implementations, the agricultural machine further comprises one or more terrain sensors operatively coupled to the controller and configured to measure at least one parameter indicative of the terrain of the work site of the agricultural machine; the one or more terrain sensors is configured to send the one or more first signals to the controller. In some implementations, the one or more first signals is associated with a terrain map indicative of terrain of a work site of the agricultural machine at specified locations of the work site.

In some implementations, the agricultural machine further comprises the work machine; and the work machine is a combine configured to thresh harvested crop received from the cutting head.

In some implementations, the one or more first signals is associated with a speed of the work machine. In some implementations, the one or more first signals is associated with a speed of the cutting head.

In some implementations, the agricultural machine further comprises: one or more work machine ground engaging mechanisms configured to propel the work machine along the ground surface; and an axle coupled to the one or more work machine ground engaging mechanisms; an axial direction is defined as substantially perpendicular to the axle; and the controller is configured to cause pivoting movement of the one or more ground engaging mechanisms of the cutting head relative to the axial direction. In some implementations, the one or more ground engaging mechanisms includes a first ground engaging mechanism and a second ground engaging mechanism; and the at least one additional signal causes pivoting movement of the first ground engaging mechanism and not the second ground engaging mechanism.

In some implementations, the agricultural machine further comprises: the work machine; and the cutting head is coupled to the work machine.

In some implementations, the at least one additional signal causes pivoting movement of the one or more ground engaging mechanisms while the cutting head is harvesting crop.

In another illustrative implementation, an agricultural machine for harvesting crop, comprises: a cutting head configured to harvest crop and conduct harvested crop to a work machine configured to process harvested crop. The cutting head includes one or more ground engaging mechanisms configured to rotate to propel the cutting head along a ground surface/The agricultural machine further comprises: a propulsion system configured to provide power to the one or more ground engaging mechanisms to drive rotation thereof; and a controller configured to cause pivoting movement of the one or more ground engaging mechanisms.

In some implementations, the agricultural machine further comprises: one or more actuators coupled to the one or more ground engaging mechanisms; the one or more actuators are configured to receive at least one signal from the controller and pivot the one or more the ground engaging mechanisms based on the at least one signal.

In another illustrative implementation, a method of propelling a cutting head for harvesting crop comprises: providing power, via a propulsion system, to one or more ground engaging mechanisms of the cutting head to drive rotation of the one or more ground engaging mechanisms and propel the cutting head along a ground surface; receiving one or more first signals via a controller; sending at least one additional signal, via the controller, to one or more actuators based on receipt of the one or more first signals, wherein the at least one additional signal causes pivoting movement of the one or more ground engaging mechanisms.

In an illustrative implementation, an agricultural machine for harvesting crop comprises: a cutting head configured to harvest crop and conduct harvested crop to a work machine configured to process harvested crop. The cutting head includes one or more ground engaging mechanisms configured to rotate to propel the cutting head along a ground surface. The agricultural machine further comprises: a propulsion system configured to provide power to the one or more ground engaging mechanisms to drive rotation thereof; and a controller configured to receive one or more first signals and configured to send at least one additional signal to the propulsion system based on receipt of the one or more first signals. The at least one additional signal causes or enables the propulsion system to change the propulsion of the cutting head along the ground surface.

In some implementations, the at least one additional signal switches the propulsion system between a first mode in which the propulsion system provides no power to the one or more ground engaging mechanisms and a second mode in which the propulsion system provides power to the one or more ground engaging mechanisms. In some implementations, in response to receipt of the at least one additional signal, the propulsion system provides power to the one or more ground engaging mechanisms at a designated torque or change in torque. In some implementations, in response to receipt of the at least one additional signal, the propulsion system provides power to the one or more ground engaging mechanisms at a designated speed or change in speed.

In some implementations, the propulsion system comprises a motor configured to provide power to the one or more ground engaging mechanisms; and the motor is configured to generate energy. In some implementations, the agricultural machine comprises one or more load sensors configured to send the one or more first signals to the controller; the one or more first signals is indicative of a load on the cutting head.

In some implementations, the agricultural machine further comprises: one or more load sensors configured to send the one or more first signals to the controller; and a feederhouse configured to receive harvested crop from the cutting head; the one or more first signals is indicative of a load on the feederhouse. In some implementations, the agricultural machine further comprises: one or more load sensors configured to send the one or more first signals to the controller; the one or more first signals are indicative of images of crop and debris engaged by the cutting head and not conducted to the work machine.

In some implementations, the one or more first signals is associated with a terrain of a work site of the agricultural machine; and the terrain of the worksite includes at least one of pitch and roll of the worksite. In some implementations, the agricultural machine further comprises one or more terrain sensors operatively coupled to the controller and configured to measure at least one parameter indicative of the terrain of the work site of the agricultural machine; the one or more terrain sensors is configured to send the one or more first signals to the controller.

In some implementations, the one or more first signals is associated with a soil condition of a work site of the agricultural machine; and the soil condition of the worksite includes at least one of soil moisture, soil type, soil firmness, and soil adhesion. In some implementations, the agricultural machine further comprises one or more soil condition sensors operatively coupled to the controller and configured to measure at least one parameter indicative of the soil condition of the work site of the agricultural machine; the one or more soil condition sensors is configured to send the one or more first signals to the controller.

In some implementations, the one or more first signals is associated with at least one of: a terrain map indicative of terrain of a work site of the agricultural machine at specified locations of the work site, wherein the terrain of the worksite includes at least one of pitch and roll of the worksite; and a soil map indicative of soil condition of a work site of the agricultural machine at specified locations of the work site, wherein soil condition of the worksite includes at least one of soil moisture, soil type, soil firmness, and soil adhesion.

In some implementations, the one or more first signals is associated with a future need for a change in propulsion of the cutting head.

In some implementations, the agricultural machine further comprises the work machine; and the work machine is a combine configured to thresh harvested crop received from the cutting head. In some implementations, the one or more first signals is indicative of at least one of: slip of one or more ground engaging mechanisms of the cutting head; and slip of one or more work machine ground engaging mechanisms.

In some implementations, the one or more first signals is associated with at least one of a speed of the work machine and a rotational speed one more work machine ground engaging mechanisms. In some implementations, the one or more first signals is associated with at least one of a speed of the cutting head and a rotational speed of the one more ground engaging mechanisms of the cutting head.

In some implementations, the agricultural machine further comprises the work machine; and the cutting head is coupled to the work machine.

In some implementations, the at least one additional signal causes the propulsion system to change the propulsion of the cutting head while the cutting head is harvesting crop.

In another illustrative implementation, an agricultural machine for harvesting crop, comprises: a cutting head configured to harvest crop and conduct harvested crop to a work machine configured to process harvested crop. The cutting head includes one or more ground engaging mechanisms configured to rotate to propel the cutting head along a ground surface. The agricultural machine further comprises: a propulsion system configured to provide power to the one or more ground engaging mechanisms to drive rotation thereof; and a controller configured to send at least one signal to the propulsion system that causes or enables a change in propulsion of the cutting head along the ground surface.

In another illustrative implementation, a method of propelling a cutting head for harvesting crop comprises: providing power, via a propulsion system, to one or more ground engaging mechanisms of the cutting head to drive rotation of the one or more ground engaging mechanisms and propel the cutting head along a ground surface; receiving one or more first signals via a controller; and sending at least one additional signal, via the controller, to the propulsion system based on receipt of the one or more first signals. The at least one additional signal causes a change in propulsion of the cutting head along the ground surface.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side view of an example agricultural machine configured to harvest and process crop in a worksite;

FIG. 2A is a diagrammatic view of a cutting head configured to harvest crop and a work machine configured to process the harvested crop, and FIG. 2A shows an example propulsion system located partially on the cutting head and partially on the work machine;

FIG. 2B is a diagrammatic view of a cutting head configured to harvest crop and a work machine configured to process the harvested crop, and FIG. 2B shows an example propulsion system located entirely on the cutting head;

FIG. 3A is a diagrammatic view of an example propulsion system including a battery and an electric motor configured to power ground engaging mechanisms of a cutting head;

FIG. 3B is a diagrammatic view of an example propulsion system including a hydraulic pump and a motor configured to power ground engaging mechanisms of a cutting head;

FIG. 4A is an exemplary diagrammatic view of a motor configured to power a ground engaging mechanism and rotate about a drive axis aligned with a driven axis about which the ground engaging mechanism rotates;

FIG. 4B is an exemplary diagrammatic view of a motor configured to power a ground engaging mechanism and rotate about a drive axis that is not aligned with a driven axis about which the ground engaging mechanism rotates;

FIG. 5 is a diagrammatic view of a cutting head configured to harvest crop and a work machine configured to process the harvested crop, and FIG. 5A shows actuators configured to move components of the cutting head and the work machine to redistribute the load on the cutting head;

FIG. 6 is a diagrammatic view of an example control system for the agricultural machine including a controller configured to receive one or more first signals from at least one of a plurality of sensors, a user interface, and a memory and send at least one additional signal to at least one of cutting head brakes, a plurality of actuators, and a propulsion system based on the one or more first signals;

FIG. 7 is a flow diagram showing an example method associated with adjusting the power provided by the propulsion system to ground engaging mechanisms of the cutting head;

FIG. 8 is a flow diagram showing an example method associated with moving one or more actuators configured to one or more pivot ground engaging mechanism of the cutting head;

FIG. 9 is a flow diagram showing an example method associated with coupling a cutting head to a work machine configured to process harvested crop received from the cutting head;

FIG. 10 is a flow diagram showing an example method associated with redistributing load on a cutting head and adjusting power provided by the propulsion system to ground engaging mechanisms of the cutting head; and

FIG. 11 is a flow diagram showing an example method associated with engaging and disengaging cutting head brakes based on one or more first signals received by a controller of the agricultural machine.

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

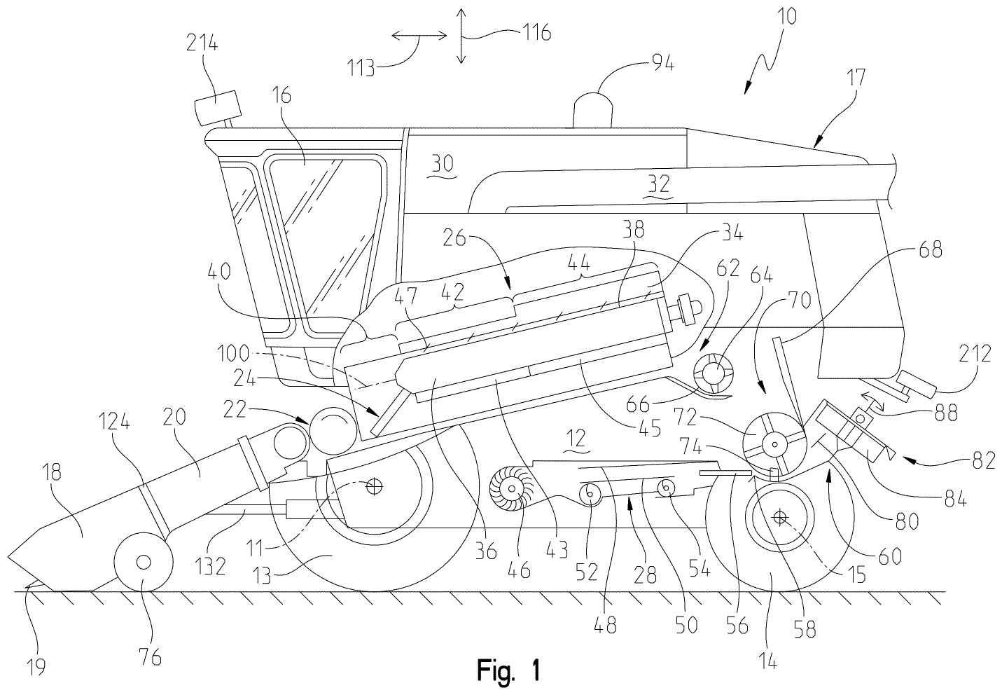

In FIG. 1, an implementation of an agricultural machine 10 is shown. The agricultural machine 10 includes a work machine 17 (e.g., a combine, sugar cane harvester, cotton harvester, self-propelled forage harvester, or windrower) and cutting head 18 that is coupleable to the work machine 17. The cutting head 18 is configured to harvest crop and conduct harvested crop to the work machine 17. The work machine 17 is configured to process the harvested crop received from the cutting head 18.

In the illustrative implementation, the work machine 17 includes a chassis 12, one or more front work machine ground engaging mechanisms 13, and one or more rear work machine ground engaging mechanisms 14. The front and rear work machine ground engaging mechanisms 13, 14 may be wheels (as illustratively shown) or tracks, which may be, in either case, elastomeric or steel, for example. The work machine ground engaging mechanisms 13, 14 are configured to contact an underlying ground surface and support the chassis 12 above the ground. In the illustrative implementation, the front work machine ground engaging mechanisms 13 are coupled to a front axle 11 that extends in a lateral direction, and the rear work machine ground engaging mechanisms 14 are coupled to a rear axle 15 that extends in the lateral direction (into the page in FIG. 1). An axial direction, which is shown by the double-headed arrow 113, is perpendicular to the lateral direction. In other words, the axial direction 113 is substantially perpendicular to the axles 11, 15. In FIG. 1, the double headed arrow 116 represents the vertical direction, which is perpendicular to the axial and lateral directions in the illustrative implementation. The work machine ground engaging mechanisms 13, 14 are coupled to the chassis 12 and are configured to rotate to move the work machine 17 in a forward operating direction (which is to the left in FIG. 1) and in other directions.

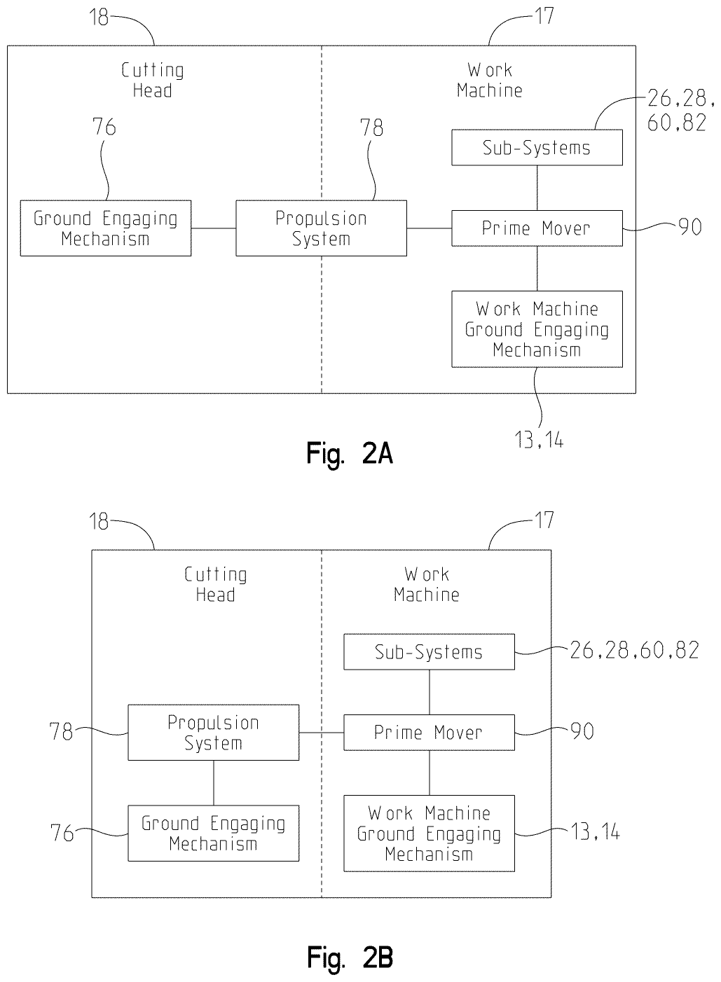

As shown in FIGS. 2A-B, in the illustrative implementation, the work machine 17 includes a prime mover 90 configured to consume fuel and output mechanical energy, electrical energy, or both. For example, the prime mover 90 may power the work machine ground engaging mechanisms 13, 14 and a plurality of subsystems of the work machine 17 that are configured to process harvested crop. The sub-systems of the work machine 17 include a threshing assembly 26, a clean crop routing assembly 28, a crop debris routing assembly 60, and a residue assembly 82, each of which are described in detail below.

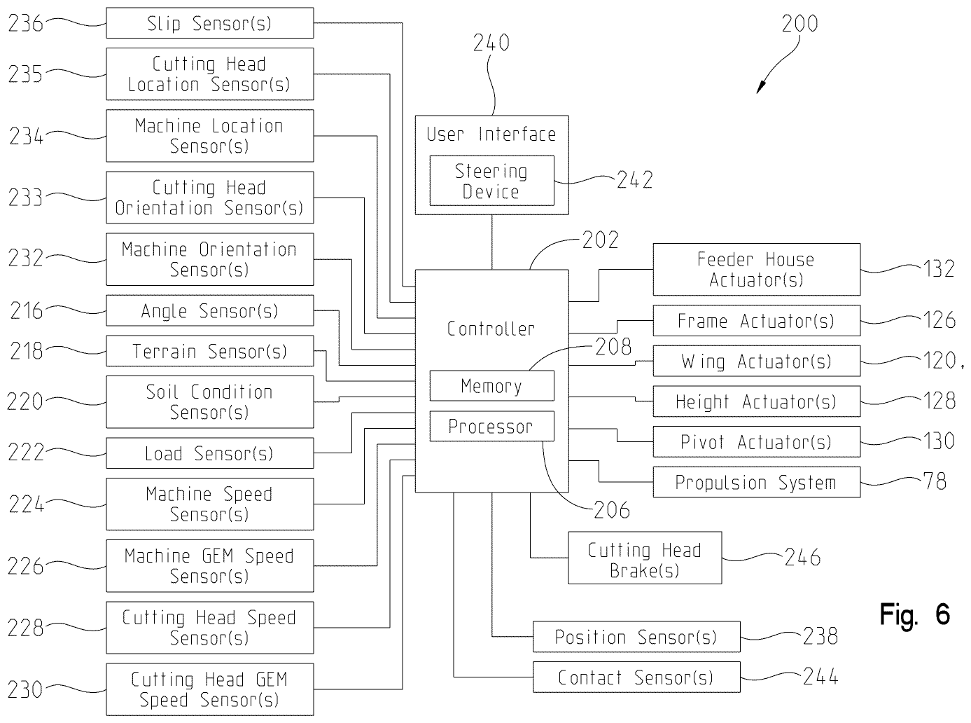

Referring again to FIG. 1, in some implementations, operation of the agricultural machine 10 is controlled from an operator's cab 16. The operator's cab 16 may include any number of controls for controlling the operation of the agricultural machine 10, such as a user interface 240, which is shown in FIG. 6. For example, the user interface 240 may include a steering device 242 configured to receive input from a user associated with pivoting movement of the one or more work machine ground engaging mechanisms 13, 14 relative to the axial direction 113. It should be appreciated that in some implementations, the user interface 240 is located away from the agricultural machine 10. Operation of the agricultural machine 10 may be conducted by a human operator in the operator's cab 16, a remote human operator, or an automated system (e.g., a controller 202 described herein).

As shown in FIG. 1, the cutting head 18 is disposed at a forward end of the agricultural machine 10. In some implementations, the cutting head 18 is coupled to the work machine 17. For example, in some implementations, the cutting head 18 is mechanically attached to the work machine 17 for movement therewith. In some implementations, the agricultural machine 10 is reconfigurable between a first configuration and a second configuration. In the first configuration, the cutting head 18 is spaced apart from the work machine 18. In the second configuration, the cutting head is coupled to the work machine. The cutting head 18 is configured to harvest crop. The term harvest as used herein includes cutting, collecting, gathering, or otherwise obtaining crop from a work site during an agricultural operation. For example, in some implementations, the cutting head 18 includes a cutting bar 19 configured to cut crop. The term harvested crop as used herein includes grain (e.g., corn, wheat, soybeans, rice, oats) and material other than grain (MOG). The cutting head 18 may be a corn head, a cutting platform (e.g., including a reel assembly), a draper, a belt pick-up assembly, or any other head configured to harvest crop in a worksite. As shown in FIG. 1, among others, the cutting head 18 includes one or more ground engaging mechanisms 76 configured to rotate to propel the cutting head 18 along a ground surface. In some implementations, as shown in FIG. 6, the cutting head 18 includes cutting head brakes 246 configured, when engaged, to cease or slow the rotation of the one or more ground engaging mechanisms 76.

In the illustrative implementations, as shown in FIGS. 2A-B, the agricultural machine 10 includes a propulsion system 78 configured to provide power to the one or more ground engaging mechanisms 76 to drive rotation thereof. In some implementations, the propulsion system 78 provides power to the one or more ground engaging mechanisms 76 to drive rotation of the one or more ground engaging mechanisms 76 while the cutting head is harvesting crop (i.e., during a harvesting operation). The prime mover 90 powers the propulsion system 78. In some implementations, the propulsion system 78 may generate its own power as well, for example, via regenerative braking as described in greater detail herein. As shown in FIG. 2A, in some implementations, the propulsion system 78 is located on both the cutting head 18 and the work machine 17. As shown in FIG. 2B, in some implementations, the propulsion system is located entirely on the cutting head 18. As shown in FIGS. 2A-B, the cutting head 18 is coupleable to the work machine 17. In some implementations, attachment of the cutting head 18 to the work machine 17 couples portions of the propulsion system 78 to one another. In some implementations, attachment of the cutting head 18 to the work machine 17 couples the propulsion system 78 to the prime mover 90.

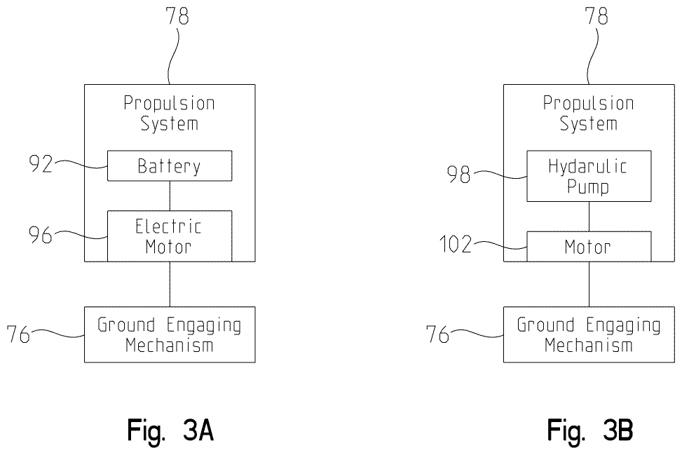

In some implementations, as shown in FIG. 3A, the propulsion system 78 includes a battery 92 coupled to and configured to power an electric motor 96. In the illustrative implementation, the battery 92 and the electric motor 96 are each located on the cutting head 18. However, in other implementations, the battery 92 may be located on the work machine 17. In some implementations, the battery 92 is rechargeable by the prime mover 90, which provides energy to the battery 92. In some implementations, the battery 92 is rechargeable using energy from an electric power grid. Using power from the battery 92, the electric motor 96 rotates to provide power to the one or more ground engaging mechanisms 76 to drive rotation thereof. In some implementations, the propulsion system 90 is embodied as regenerative braking system. For example, the electric motor 96 is configured to generate energy via reverse current flow (e.g., during deceleration of the cutting head 18 or, more generally, when the one or more ground engaging mechanisms 76 are moved along the ground surface without propelling the cutting head 18 along the ground surface). In some implementations, the energy generated by the regenerative braking system is stored by the battery 92.

In some implementations, as shown in FIG. 3B, the propulsion system 78 includes a hydraulic pump 98 that is located on the work machine 17 and a motor 102 (e.g., a piston motor) that is coupled to the hydraulic pump 98 and located on the cutting head 18. The hydraulic pump 98 receives mechanical energy from the prime mover 90 and converts the mechanical energy into fluid energy (i.e., pressure). The motor 102 converts the fluid energy back into mechanical energy to power the one or more ground engaging mechanisms 76 and drive rotation thereof.

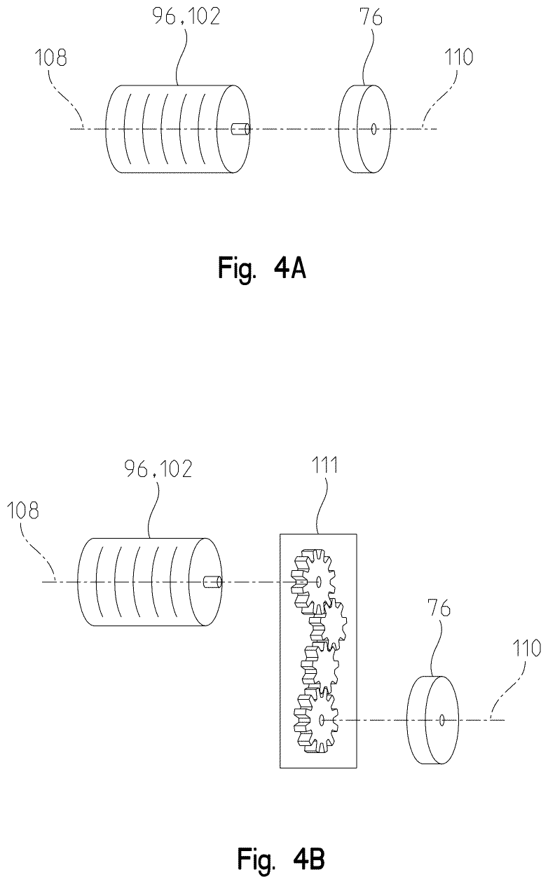

In some implementations, as shown in FIG. 4A-B, the propulsion system 78 includes a motor (e.g., motor 96 or motor 102) that is configured to rotate about a drive axis 108 to provide power to a first ground engaging mechanism of the one or more ground engaging mechanisms 76. The first ground engaging mechanism rotates about a driven axis 110. In some implementations, as shown in FIG. 4A, the drive axis 108 and the driven axis 110 are aligned. In some implementations, as shown in FIG. 4B, the drive axis 108 and the driven axis 110 are not aligned. For example, the motor 96, 102 may be coupled to a first drive shaft that is aligned with the drive axis 108; the first drive shaft may be coupled to one or more gear boxes 111; the one or more gear boxes 111 may be coupled to a second drive shaft, which is aligned with the driven axis 110 and coupled to the first ground engaging mechanism. In such implementations, the motor 96, 102 may be positioned away from the one or more ground engaging mechanisms 76, which may decrease the wear and tear on the motor 96, 102.

In some implementations, the propulsion system 78 includes a plurality of motors (e.g., motors 96 or motors 102) each configured to provide power to at least one of the one or more ground engaging mechanisms 76. For example, a first motor may be configured to provide power to a first one or more ground engaging mechanisms and a second motor may be configured to provide power to a second one or more ground engaging mechanisms. In some implementations, the first motor does not provide power to the second one or more ground engaging mechanisms, and the second motor does not provide power to the first one or more ground engaging mechanisms. In some implementations, each ground engaging mechanism of the one or more ground engaging mechanisms 76 is powered by a separate motor. In such implementations, the motors 96, 102 may provide different levels of power to different ground engaging mechanisms simultaneously.

In some implementations, the propulsion system 78 includes a compressed air system to pneumatically power the one or more ground engaging mechanisms 76 to drive rotation thereof. The compressed air system may be located entirely on the cutting head 18 or distributed across the cutting head 18 and the work machine 17. The compressed air system may include a compressor and a motor (e.g., electric) configured to power the compressor. In some implementations, the motor is powered by the prime mover 90. In any event, compressed air is used to power the one or more ground engaging mechanisms 76 to drive rotation thereof. In some implementations, the compressed air powers an electric motor configured to power the one or more ground engaging mechanisms 76.

In some implementations, the propulsion system 78 includes a combustion engine located on the cutting head 18 to power the one or more ground engaging mechanisms 76 to drive rotation thereof. The combustion engine uses fuel to create mechanical energy used to power the one or more ground engaging mechanisms 76.

In some implementations, the one or more ground engaging mechanisms 76 are powered via a rotating drive shaft coupled to a power take off unit located on a feederhouse 20 of the work machine 17 that is configured to receive harvested crop from the cutting head 18.

In some implementations, mechanical energy output from the prime mover 90 is used to power a gear box, which in turn powers the one or more ground engaging mechanisms 76. For example, the mechanical energy output from the prime mover 90 drives rotation of gears of the gear box, which in turn, drive rotation of the one or more ground engaging mechanisms 76.

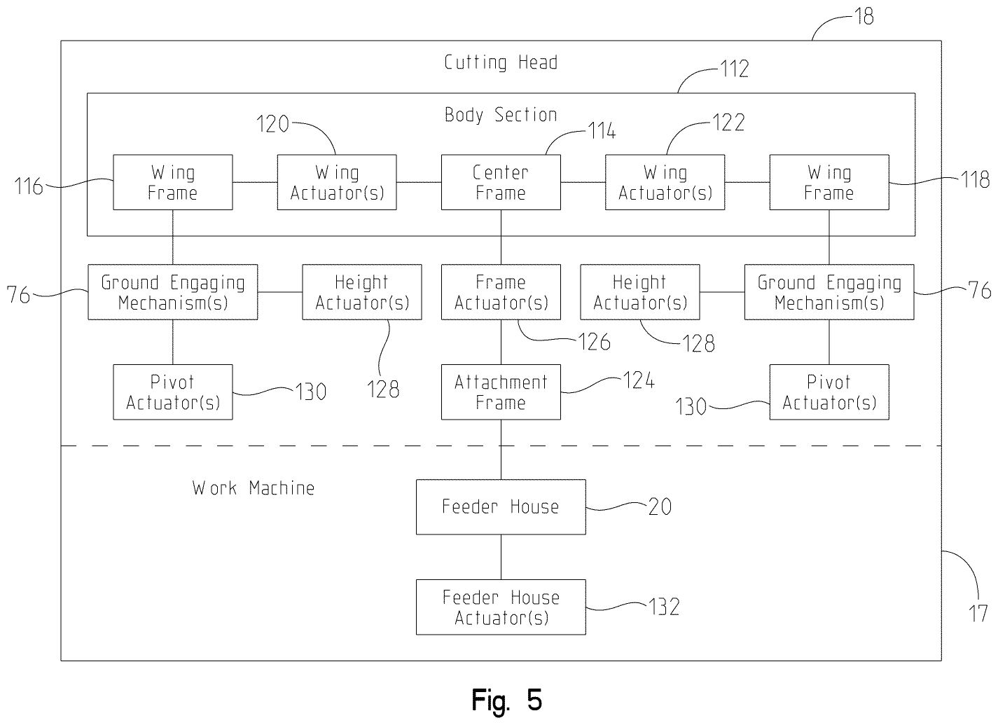

Referring now to FIG. 5, a diagrammatic view of the cutting head 18 and the feeder house 20 of the work machine 17 is shown. The cutting head 18 includes a body section 112 including a center frame 114, a first wing frame 116 coupled to a first side of the center frame 114, and a second wing frame 118 coupled to a second side of the center frame 114. In the illustrative implementation, the body section 112 includes the cutting bar 19 that is configured to harvest crop and includes one or more augers, one more or conveyors, or both that are configured to conduct the harvested crop to the feeder house 20 of the work machine 17.

Referring still to FIG. 5, in the illustrative implementation, the first and second wing frames 116, 118 of the body section 112 are pivotably coupled to the center frame 114, which optimizes ground following of each portion of the cutting head 18. In the illustrative implementation, the body section 112 includes one or more wing actuators 120 configured to extend and retract to pivot the first wing frame 116 relative to the center frame 114 and one or more wing actuators 122 configured to extend and retract to pivot the second wing frame 118 relative to the center frame 114. In the illustrative implementation, the one or more wing actuators 120 are coupled to the center frame 114 and the first wing frame 116, and the one or more wing actuators 122 are coupled to the center frame 114 and the second wing frame 118. Movement of the one or more wing actuators 120, 122 redistributes the load on the cutting head 18. For example, as the actuators 120, 122 are adjusted to pivot the distal ends of the wing frames 116, 118 upward, load shifts away from the cutting head 18 and onto the work machine 17. Additionally, as the actuators 120, 122 are adjusted to pivot the distal ends of the wing frames 116, 118 upward, load shifts away from the wing frames 116, 118 and onto the center frame 114). Conversely, as the actuators 120, 122 are adjusted to pivot the distal ends of the wing frames 116, 118 downward, load shifts away from the work machine 17 and onto the cutting head 18. Further, as the actuators 120, 122 are adjusted to pivot the distal ends of the wing frames 116, 118 downward, load shifts away from the center frame 114 and onto the wing frames 116, 118.

Referring still to FIG. 5, in the illustrative implementation, the body section 112 is pivotably coupled to an attachment frame 124. Specifically, in the illustrative implementation, the center frame 114 is pivotably coupled to the attachment frame 124. The attachment frame 124 is coupleable at its first (e.g., rearward facing) side to the feeder house 20 and at its second (e.g., forward facing) side to the center frame 114. In the illustrative implementation, one or more frame actuators 126 are coupled to the body section 112 (e.g., the center frame 114 thereof) and to the attachment frame 124. The one or more frame actuators 126 are configured to extend and retract to pivot the body section 112 relative to the attachment frame 124 and relative to the feeder house 20. In other words, in the illustrative implementation, the one or more frame actuators 126 are configured to extend and retract to pivot the cutting head 18 relative to the work machine 17. Movement of the one or more frame actuators 126 redistributes the load on the cutting head 18. For example, adjusting the one or more frame actuators 126 to cause the forward facing side of the attachment frame 124 to pivot upward shifts load away from the cutting head 18 and onto the work machine 17, and adjusting the one or more frame actuators 126 to cause the forward facing side of the attachment frame 124 to pivot downward shifts load away from the work machine 17 and onto the cutting head 18.

Referring still to FIG. 5, in the illustrative implementation, the cutting head 18 includes one or more height actuators 128 configured to extend and retract to move the body section 112 of the cutting head 18 relative to the one or more ground engaging mechanisms 76 of the cutting head 18. For example, in the illustrative implementation, the one or more height actuators 128 extend to move the body section 112 upward, away from the one or more ground engaging mechanisms 76 and contract to move the body section 112 downward, toward the one or more ground engaging mechanisms 76. Movement of the one or more height actuators 128 redistributes the load on the cutting head 18. For example, extension of the one or more height actuators 128 shifts load away from the work machine 17 onto the cutting head 18, and retraction of the one or more height actuators 128 shifts load away from the cutting head 18 onto the work machine 17. In some implementations, the one or more ground engaging mechanisms 76 are coupled to first ends of struts, and the struts are coupled at their second ends to the body section 112 (e.g., the struts may be coupled to the body section 112 at the wing frames 116, 118). In some implementations, the struts are pivotably or slidably coupled one another to facilitate vertical movement of the body section 112 relative to the ground engaging mechanisms 76. The one or more height actuators 128 are coupled to the wing frames 116, 118 and the one or more ground engaging mechanisms 76 (in some implementations via the struts), and the one or more height actuators 128 extend and retract to move the body section 112 relative to the one or more ground engaging mechanisms 76.

Referring still to FIG. 5, in the illustrative implementation, the work machine 17 includes a feeder house actuator 132 configured to extend and retract to move the feeder house 20. For example, extension of the feeder house actuator 132 pivots a front end of the feeder house 20 upward, and retraction of the feeder house actuator 132 pivots the front end of the feeder house 20 downward. Movement of the one or more feeder house actuators 132 redistributes the load on the cutting head 18. For example, movement of the front end of the feeder house 20 upward shifts load away from the cutting head 18 onto the work machine 17, and movement of the front end of the feeder house 20 downward shifts load away from the work machine 17 onto the cutting head 18. It should be appreciated that the phrase redistributes load on the cutting head 18 includes redistributing load across the cutting head (e.g., via actuators 120, 122) and redistributing load between the cutting head 18 and the work machine 17 (e.g., via actuators 126, 128, 132).

As shown in FIG. 5, in the illustrative implementation, the cutting head 18 includes one or more pivot actuators 130 configured pivot the one or more ground engaging mechanisms 76 (e.g., relative to the axial direction 113). In some implementations, the pivot actuators 130 extend and retract to pivot the one or more ground engaging mechanisms 76. While FIG. 5 shows a center frame 114, a first wing frame 116, and a second wing frame 118, it should be appreciated that in some implementations, the cutting head 18 may include additional wing frames located outside the first and second wing frames. In some implementations, the cutting head 18 may include a center frame 114 with no wing frames attached thereto. In some implementations, the center frame 114 may include a first side and a second side, wherein the first side and the second side are movable relative to one another, for example, via a center actuator that is coupled to the first side and the second side and adjustable by the controller 202.

It should be appreciated that while each actuator 120, 122, 136, 128, 130, 132 herein has been illustratively described as an actuator that extends and retracts (e.g., a linear actuator), multiple types of actuators are contemplated by this disclosure. For example, the pivot actuators 130 (and each other actuator described herein) may be embodied as rotary actuators, rack and pinion actuators, linear actuators, or any other suitable type of actuator for causing the movement of the associated components described herein.

Referring again to FIG. 1, the cutting head 18 is configured to conduct the harvested crop to the feeder house 20. Upon receiving the harvested crop from the cutting head 18, the feeder house 20 conducts the harvested crop to a guide drum 22. The guide drum 22 guides the harvested crop to an inlet 24 of a threshing assembly 26, as shown in FIG. 1. The threshing assembly 26 includes a housing 34 and one or more threshing rotors. A single threshing rotor 36 is shown in FIG. 1. The threshing rotor 36 includes a drum 38 arranged along a threshing axis 100, and the threshing rotor 36 rotates about the threshing axis 100.

As shown in FIG. 1, the threshing assembly 26 further includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44. The threshing assembly 26 further includes a thresher basket 43 that is positioned in the threshing section 42 and below the threshing rotor 36, guide vanes 47 that are positioned above the threshing rotor 36, and a separating grate 45 that is positioned in the separating section 44 and below the threshing rotor 36. In the illustrative implementation, the guide vanes 47 guide harvested crop rearwardly through the threshing assembly 26, and the harvested crop is separated and expands as it engages with the guide vanes 47. Harvested crop falls through the thresher basket 43 and through the separating grate 45.

As shown in FIG. 1, the harvested crop may be directed to the clean crop routing assembly 28 with a blower 46 and sieves 48, 50 with louvers. The sieves 48, 50 can be oscillated axially. The clean crop routing assembly 28 removes MOG and guides grain over a screw conveyor 52 to a grain elevator 94. The grain elevator 94 deposits the grain in a grain tank 30, as shown in FIG. 1. The grain in the grain tank 30 can be unloaded by means of an unloading screw conveyor 32 to a grain wagon, trailer, or truck, for example.

As shown in FIG. 1, harvested crop remaining at a rear end of the sieve 50 is again transported to the threshing assembly 26 by a screw conveyor 54 where the harvested crop is reprocessed by the threshing assembly 26. Harvested crop remaining at a rear end of the sieve 48 is conveyed by an oscillating sheet conveyor 56 to a lower inlet 58 of a crop debris routing assembly 60. Harvested crop at the threshing assembly 26 is processed by the separating section 44 resulting in straw being separated from other material of the harvested crop. The straw is ejected through an outlet 62 of the threshing assembly 26 and conducted to an ejection drum 64. The ejection drum 64 interacts with a sheet 66 arranged underneath the ejection drum 64 to move the straw rearwardly. A wall 68 is located to the rear of the ejection drum 64 and guides the straw into an upper inlet 70 of the crop debris routing assembly 60. In the crop debris routing assembly 60, blades of a rotatable chopper 72 interact with knives 74 to chop the straw into smaller harvested crop residue.

As shown in FIG. 1, harvested crop residue moves from the crop debris routing assembly 60 to the residue assembly 82 for optional subsequent processing and ejection from the agricultural machine 10. For example, the residue assembly includes one or more spreaders provided downstream of an outlet 80 of the crop debris routing assembly 60. One spreader 84 is shown in FIG. 1. Rotation of blades of the spreader 84 about an axis 88 spreads the chopped straw as the chopped straw exits the agricultural machine 10.

It should be appreciated that while an exemplary agricultural machine 10 is described with reference to FIG. 1, aspects of the disclosure, such as the functions of the cutting head 18, the functions of the control system 200, and the methods 700, 800, 900, 1000, and 1100 are usable in connection various agricultural machines configured to process crop.

Referring now to FIG. 6, an example control system 200 is shown. The control system 200 includes one or more memories 208 included in or accessible by the controller 202 and one or more processors 206 included in or accessible by the controller 202. The one or more processors 206 are configured to execute instructions (e.g., one or more algorithms) stored on the one or more memories 208. The controller 202 may be a single controller or a plurality of controllers operatively coupled to one another. The controller 202 may be located on the agricultural machine 10, located remotely (i.e., away from the agricultural machine 10), or both. The controller 202 may be located on the work machine 17, on the cutting head 18, or both. The controller 202 may be coupled via a wired connection or wirelessly to other components of the agricultural machine 10 and to one or more remote devices. In some instances, the controller 202 may be connected wirelessly via Wi-Fi, Bluetooth, Near Field Communication, or another wireless communication protocol to other components of the agricultural machine 10 and to one or more remote devices.

Referring still to FIG. 6, in the illustrative implementation, the controller 202 is operatively coupled to a plurality of sensors including: at least one angle sensor 216, at least one terrain sensor 218, at least one soil conduction sensor 220, at least one load sensor 222, at least one machine speed sensor 224, at least one machine ground engaging mechanism (GEM) speed sensor 226, at least one cutting head speed sensor 228, at least one cutting head ground engaging mechanism (GEM) speed sensor 230, and least one machine orientation sensor 232, at least one machine location sensor 234, at least one cutting head location sensor 235, at least one slip sensor 236, at least one position sensor 238, and at least one contact sensor 244. In some implementations, the controller 202 is configured to receive one or more first signals and send at least one additional signal based on receipt of the one or more first signals. In some implementations, the one or more first signals is sent from the one or more sensors 212, 214, 216, 218, 220, 222, 224, 226, 228, 230, 232, 233, 234, 235, 236, 238, 244. Each sensor is configured to measure at least one parameter and send one or more first signals to the controller 202 indicative of the at least one measured parameter.

Referring still to FIG. 6, in some implementations, the one or more first signals is sent from the user interface 240. In some implementations, the at least one additional signals cause actuation of one or more actuators 120, 122, 126, 128, 130, 132. In some implementations, the at least one additional signals cause engagement or disengagement of the cutting head brakes 246. In some implementations, the at least one additional signals cause a change in the power provided by the propulsion system 78 to the one or more ground engaging mechanisms 76 of the cutting head 18. In the illustrative implementations, the at least one additional signal from the controller 202 causes actuation of one or more actuators 120, 122, 126, 128, 130, 132 of the cutting head 18, change in power provided by the propulsion system 78 to the one or more ground engaging mechanisms 76 of the cutting head 18, or both. Other systems may include controllable, powered ground engaging mechanisms for trailers onto which a cutting head may be loaded; however, the illustrative implementation is directed to actuation and propulsion of the cutting head 18 itself.

In the illustrative implementation, the at least one angle sensor 216 is configured to measure at least one parameter indicative the angle of one or more work machine ground engaging mechanisms 13, 14. The at least one angle sensor 216 may be an image sensor, an angular position sensor (i.e., a rotary encoder), a potentiometer, or any other type of sensor suitable for measuring an angle or change in angle of the one or more work machine ground engaging mechanisms 13, 14. For example, in some implementations, the work machine 17 includes image sensors 212, 214 configured to capture one or more images of a field of view external to the agricultural machine 10. In some implementations, the image sensors 212, 214 may be embodied as one or more cameras (e.g., optical or visual radiation cameras or red, green, blue (RGB) cameras), LiDAR sensors, radar sensors (e.g., long-range terahertz radar, mm wave radar, ultra-wideband radar, frequency-modulated continuous wave radar (FMCW), ground penetrating radar), ultrasonic sensors, thermal sensors (e.g., a thermal cameras), stereo cameras, laser vibrometers, infrared nuclear magnetic resonance (NMR) cameras, short-wave infrared (SWIR) cameras, terahertz sensors, or other sensors operable to capture or generate one or more images or data corresponding to the one or more images of the field of view. In the illustrative implementation, the angle of the one or more work machine ground engaging mechanisms 13, 14 may be measured or determined relative to the axial direction 113. The at least one angle sensor 216 is configured to send one or more first signals to the controller 202 indicative of the angle of the one or more work machine ground engaging mechanisms 13, 14.

In the illustrative implementation, the at least one terrain sensor 218 is configured to measure at least one parameter indicative of the terrain of a portion of a work site of the agricultural machine 10. The terrain of the worksite includes at least one of pitch and roll of the worksite. In the illustrative implementation, the at least one terrain sensor 218 may be an image sensor or any other type of sensor suitable for measuring the terrain of the work site. The at least one terrain sensor 218 is configured to send one or more first signals to the controller 202 indicative of the terrain of a portion of the work site of the agricultural machine 10. In some implementations, the one or more first signals are associated with a terrain map indicative of terrain of the work site of the agricultural machine 10 at specified locations of the work site. For example, the terrain map may be stored in the memory 208 and accessed the controller 202.

In the illustrative implementation, the at least one soil condition sensor 220 is configured to measure at least one parameter indicative of the soil condition of a portion of the work site of the agricultural machine 10. The soil condition of the worksite includes at least one of soil moisture, soil type, soil firmness, and soil adhesion. In the illustrative implementation, the at least one soil condition sensor 220 may be an image sensor, a moisture sensor, a compaction sensor, or any other type of sensor suitable for measuring the soil condition of the work site. The at least one soil condition sensor 220 is configured to send one or more first signals to the controller 202 indicative of the soil condition of a portion of the work site of the agricultural machine 10. In some implementations, the one or more first signals are associated with a soil map indicative of soil condition of the work site of the agricultural machine 10 at specified locations of the work site. For example, the soil map may be stored in the memory 208 and accessed the controller 202. It should be appreciated that the term work site characteristics includes soil condition and terrain of a work site.

In some implementations, the at least one machine location sensor 234 is configured to measure at least one parameter indicative of the location of the work machine 17. For example, the at least one machine location sensor 234 may be a global positioning system (GPS) sensor. The at least one machine location sensor 234 is configured to send one or more first signals to the controller 202 indicative of the location of the work machine 17. In some implementations, one or more measured parameters (other than the location of the work machine 17) may be associated with a specified location by operation of the at least one machine location sensor 234 and the controller 202. For example, the measured terrain, soil condition, or both may be associated with a location in a worksite based on location data from the at least one work machine location sensor 234, which are sent to the controller 202 in connection with the terrain or soil condition data.

In some implementations, the one or more first signals are associated with a future travel path of the agricultural machine 10 through a work site. For example, a travel path of the agricultural machine 10 for a harvesting operation may be generated or input and stored in the memory 208. The travel path may accessed by the processor 206 of the controller 202. In some implementations, a change in the propulsion of the cutting head 18 along the ground surface, a change in the angle (e.g., relative to the axial direction 113) of the one or ground engaging mechanisms 76, or both may be based on the future travel path of the agricultural machine 10.

In some implementations, the at least one cutting head location sensor 235 is configured to measure at least one parameter indicative of the location of the cutting head 18. In some implementations, the at least one cutting head location sensor 235 is configured to measure a first location association with a first portion of the cutting head 18 and a second location associated with a second portion of the cutting head 18. In some implementations, the at least one cutting head location sensor 235 may be a global positioning system (GPS) sensor. The at least one cutting head location sensor 235 is configured to send one or more first signals to the controller 202 indicative of the location of the cutting head 18. In some implementations, one or more measured parameters (other than the location of the cutting head 18) may be associated with a specified location by operation of the at least one cutting head location sensor 234 and the controller 202.

In some implementations, the at least one machine orientation sensor 232 is configured to measure at least one parameter indicative of the orientation of the work machine 17 in a work site. The orientation of the work machine 17 is the direction that work machine 17 is facing. The at least one machine orientation sensor 232 is configured to send one or more first signals to the controller 202, which are indicative of the orientation of the work machine 17. In some implementations, the at least one machine orientation sensor 232 may be an accelerometer, a gyroscope, or any other type of sensor suitable for measuring the orientation of the work machine 17. For example, in some implementations, orientation of the work machine 17 may be determined via the controller 202 based on multiple signals received from the at least one machine location sensor 234 indicative of a direction of travel of the work machine 17, which in turn, is indicative of the direction that the work machine 17 is facing.

In some implementations, the at least one cutting head orientation sensor 233 is configured to measure at least one parameter indicative of orientation of the cutting head 18 in a work site and configured to send one or more first signals to the controller 202 indicative of the orientation of the cutting head 18. In some implementations, the at least one cutting head orientation sensor 233 may be an accelerometer, a gyroscope, or any other type of sensor suitable for measuring the orientation of the cutting head 18. For example, in some implementations, orientation of the cutting head 18 may be determined via the controller 202 based on multiple signals received from the at least one cutting head location sensor 235, which are indicative of a direction of travel of the cutting head 18, which in turn, is indicative of the direction that the cutting head 18 is facing.

In some implementations, the at least one machine speed sensor 224 is configured to measure at least one parameter indicative of the speed at which the work machine 17 is traveling. The at least one machine speed sensor 224 is configured to send one or more first signals to the controller 202 indicative of the speed of the work machine 17. In some implementations, the at least one machine speed sensor 224 may be an accelerometer, a variable reluctance magnetic sensor, or any other type of sensor suitable for measuring the speed of the work machine 17. For example, in some implementations, the speed of the work machine 17 may be determined via the controller 202 based on multiple signals received from the at least one machine location sensor 234, which collectively are indicative of the speed of the work machine 17.

In some implementations, the at least one machine ground engaging mechanism (GEM) speed sensor 226 is configured to measure at least one parameter indicative of the rotational speed of the one or more work machine ground engaging mechanisms 13, 14. For example, the at least one machine ground engaging mechanism (GEM) speed sensor 226 may be a hall effect sensor or any other type of sensor suitable for measuring the rotational speed of the one or more work machine ground engaging mechanisms 13, 14. The at least one machine ground engaging mechanism (GEM) speed sensor 226 is configured to send one or more first signals to the controller 202 indicative of the rotational speed of the one or more work machine ground engaging mechanisms 13, 14.

In some implementations, the at least one cutting head speed sensor 228 is configured to measure at least one parameter indicative of the speed at which the cutting head 18 is traveling. The at least one cutting head speed sensor 228 is configured to send one or more first signals to the controller 202 indicative of the speed of the cutting head 18. In some implementations, the at least one cutting head speed sensor 228 may be an accelerometer, a variable reluctance magnetic sensor, or any other type of sensor suitable for measuring the speed of the cutting head 18. For example, in some implementations, the speed of the cutting head 18 may be determined via the controller 202 based on multiple signals received from the at least one cutting head location sensor 235, which collectively are indicative of the speed of the cutting head 18.

In some implementations, the at least one cutting head ground engaging mechanism (GEM) speed sensor 230 is configured to measure at least one parameter indicative of the rotational speed of the one or more ground engaging mechanisms 76 of the cutting head 18. For example, the at least one cutting head ground engaging mechanism (GEM) speed sensor 230 may be a hall effect sensor or any other type of sensor suitable for measuring the rotational speed of the one or more ground engaging mechanisms 76 of the cutting head 18. The at least one cutting head ground engaging mechanism (GEM) speed sensor 230 is configured to send one or more first signals to the controller 202 indicative of the rotational speed of the one or more ground engaging mechanisms 76 of the cutting head 18.

In some implementations, the at least one slip sensor 236 is configured to measure at least one parameter indicative of the amount, degree, or existence of slip of the one or more work machine ground engaging mechanisms 13, 14, the one or more ground engaging mechanisms 76 of the cutting head 18, or both. Slip occurs when a ground engaging mechanism of the work machine 17 or of the cutting head 18 rotates without propelling the work machine 17 or the cutting head 18 along the ground surface at a rate consistent with speed or torque instruction from the controller 202. In some implementations, the at least one slip sensor 236 may be an image sensor (e.g., configured to capture one or more images of the one or more ground engaging mechanisms 13, 14, 76), a torque sensor (e.g., configured to measure the torque or change in torque required to rotate the one or more ground engaging mechanisms 13, 14, 76) or any other type of sensor suitable for measuring the slip of the one or more ground engaging mechanisms 13, 14, 76.

In some implementations, slip of the one or more ground engaging mechanisms 13, 14, 76 may be determined via the controller 202 by comparing a designated (i.e., desired) speed for the work machine 17 or cutting head 18 with a measured (i.e., actual) speed of the work machine 17 or cutting head 18. In some implementations, the desired speed may be sent to the controller 202 by the user interface 240 in the form of one or more first signals. In some implementations, the actual speed may be measured by the at least one machine speed sensor 224 or at least one cutting head speed sensor 228. In other implementations, the slip of the one or more ground engaging mechanisms 13, 14, 76 may be determined via the controller 202 by comparing the rotational speed of the work machine ground engaging mechanisms 13, 14 to the rotational speed of the cutting head ground engaging mechanisms 18. In response to determining that slip is occurring, the controller 202 adjusts the power provided by the propulsion system 78 to the one or more ground engaging mechanisms 76.

In some implementations, the slip of the one or more ground engaging mechanisms 13, 14, 76 may be determined by comparing the speed of work machine 17 or cutting head 18 to the rotational speed of the one or more ground engaging mechanisms 13, 14, 76. For example, in some implementations, the controller 202 compares a predetermined ratio between speed of the work machine 17 and rotational speed of the one or more work machine ground engaging mechanisms 13, 14 to a measured ratio between the speed of the work machine 17 (as measured by the at least one machine speed sensor 224) and the rotational speed of the one or more ground engaging mechanisms 13, 14 of the work machine 17 (as measured by the at least one machine ground engaging mechanism speed sensor 226). In some implementations, the controller 202 compares a predetermined ratio between the speed of the cutting head 18 and the rotational speed of the one or more ground engaging mechanisms 76 of the cutting head 18 to a measured ratio between the speed of the cutting head 18 (as measured by the at least one cutting head speed sensor 228) and the rotational speed of the one or more ground engaging mechanisms 76 of the cutting head 18 (as measured by the at least one cutting head ground engaging mechanism speed sensor 230). In such implementations, if the measured ratio is beyond a threshold difference from the predetermined ratio, the controller 202 adjusts the power provided by the propulsion system 78 to the one or more ground engaging mechanisms 13, 14 or 76, respectively. In some implementations, the controller 202 is configured to determines the slope of the one or more ground engaging mechanisms based on the angle of the one or more work machine ground engaging mechanisms 13, 14, the speed of the work machine 17, and the rotational speed of the one or more ground engaging mechanisms 13, 14.

In some implementations, the at least one load sensor 222 is configured to measure at least one parameter indicative of load on the cutting head 18, the work machine 17, or both. In some implementations, load measured is for a specified location on the cutting head 18 or the work machine 17. The at least one load sensor 222 is configured to send one or more first signals to the controller 202 indicative of the load on the cutting head 18, the work machine 17, or both, and one or more signals may indicate the specified location at which the load is measured. In some implementations, the at least one load sensor 222 may be a force transducer (i.e., a load cell), a hydraulic sensor, an image sensor, or any other type of sensor suitable for measuring load on the work machine 17, the cutting head 18, or both. In some implementations, the load on the cutting head 18 may change as the cutting head 18 moves through a turn in a worksite, and the load sensor 222 is configured to measure at least one parameter indicative of load on the cutting head 18 (or various portions of the cutting head 18) during the turn. In some implementations, the distribution of load on the cutting head 18 may change (e.g., across different portions of the cutting head 18, between the cutting head 18 and the work machine 18), or both. In such implementations, the load sensor 222 is configured to measure at least one parameter indicative of load on the cutting head 18 (or various locations on the cutting head 18). In some implementations, the at least one load sensor 222 is located on the feeder house 20 or elsewhere on the work machine 17, and in some implementations, the at least one load sensor 222 is located on the cutting head 18.

As shown in FIG. 1, in some implementations, the at least one load sensor 222 is embodied as the image sensors 212, 214, which in some implementations are configured to capture images of crop and debris engaged by the cutting head 18 and not conducted to the feeder house 20. This is indicative of a pile up of crop and debris (i.e., increased load) on or in front of the cutting head 18. In some implementations, the at least one load sensor 222 is indicative of a future, predicted load on the cutting head 18 or the work machine 17. For example, at least one image sensor 212 is configured to capture one or more images of crop or debris in a field that may indicate a predicted increase or decrease in load on the cutting head 18. In some implementations, work site characteristics (e.g., soil condition, terrain, historical yields) may be stored in the memory 208 and accessed by the processor 206 of the controller 202 to determine the predicted, future load on the cutting head 18 or the work machine 17.

In some implementations, the at least one position sensor 238 is configured to measure at least one parameter indicative of a position of one or more components that are movable via one or more of the actuators 120, 122, 126, 128, 130, 132. For example, in some implementations, the at least one position sensor 238 is configured to measure the position of one or more of the cutting head 18, the body section 112, the center frame 114, the wing frames 116, 118, the attachment frame 124, the one or more ground engaging mechanisms 76, and the feeder house 20. For example, the at least one position sensor 238 may be an image sensor, an ultrasonic sensor, or any other type of sensor suitable for measuring position of one or more components that are movable via one or more of the actuators 120, 122, 126, 128, 130, 132. The at least one position sensor 238 is configured to send one or more first signals to the controller 202 indicative of the position of one or more components that are movable via one or more of the actuators 120, 122, 126, 128, 130, 132.

In some implementations, the at least one position sensor 238 is configured to measure at least one parameter indicative of a position of the one or more of the actuators 120, 122, 126, 128, 130, 132. For example, the at least one position sensor 238 may be an image sensor, an ultrasonic sensor, pressure sensor, potentiometer, or any other type of sensor suitable for measuring position of the one or more of the actuators 120, 122, 126, 128, 130, 132. The at least one position sensor 238 is configured to send one or more first signals to the controller 202 indicative of the position of the one or more actuators 120, 122, 126, 128, 130, 132. In the illustrative implementations, it should be appreciated that the position of the one or more components that are movable via one or more of the actuators 120, 122, 126, 128, 130, 132 or the position of the one or more actuators 120, 122, 126, 128, 130, 132 may be indicative of the load on the cutting head 18.

In some implementations, the controller 202 determines or monitors the power required by the sub-systems 26, 28, 60, 82 of the work machine 17, the work machine ground engaging mechanisms 13, 14, the ground engaging mechanisms 76 of the cutting head 18, the propulsion system 78, and other components of the agricultural machine 10. In some implementations, a future crop processing power requirement for such systems may be determined by the controller 202 in response to one or more first signals received by the controller 202. For example, the controller 202 may receive one or more first signals indicative of a work site characteristic (e.g., soil condition, terrain, historical yields) or a crop characteristic (e.g., volume, mass, moisture, color) associated with a need for a future power increase or decrease for the sub-systems 26, 28, 60, 82, the work machine ground engaging mechanisms 13, 14, the ground engaging mechanisms 76 of the cutting head 18, the propulsion system 78, and other components of the agricultural machine 10.

In some implementations, the future need for a change in propulsion of the cutting head 18 may be based on the future propulsion required by the cutting head 18 itself (as opposed to being limited by power requirements of other components of the agricultural machine 10). For example, the controller 202 may receive one or more first signals indicative of the terrain of the work site. The terrain may include an upward slope in the travel path of the agricultural machine 10 causing a need for additional power to be provided to the one or more ground engaging mechanisms 76 (via the propulsion system 78) when the cutting head reaches the upward slope. Thus, in response to receiving the one or more first signals indicative of the forthcoming upward sloping terrain, the controller 202 is configured to send at least one additional signal to the propulsion system 78 causing an increase the power provided by the propulsion system 78 to the one or more ground engaging mechanisms 76 when the agricultural machine 10 reaches the upward sloping terrain.

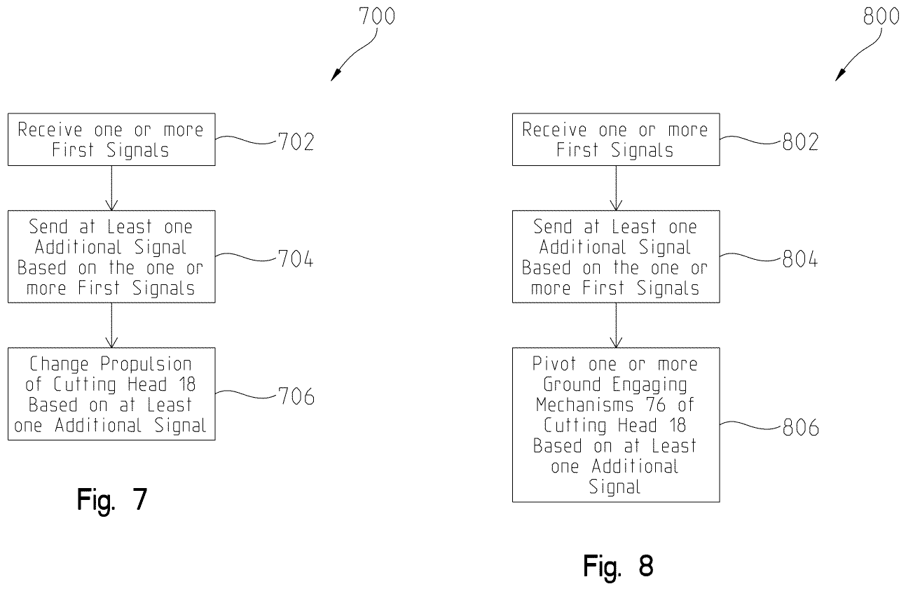

As shown in FIG. 7, in an example method 700, the control system 200 is usable to change the propulsion of the cutting head 18 along a ground surface. In the illustrative implementation, at a block 702, the controller 202 receives one or more first signals from the user interface 240, from one or more of the sensors 212, 214, 216, 218, 220, 222, 224, 226, 228, 230, 232, 233, 234, 235, 236, 238, 244 or by accessing the memory 208. At a block 704, the controller 202 sends at least one additional signal based on receipt of the one or more first signals. In the illustrative implementation, the controller 202 sends the at least one additional signal to the propulsion system 78, which causes or enables the propulsion system 78 to change the propulsion of the cutting head 18 along the ground surface as shown at a block 706. In some implementations, the at least one additional signal switches the propulsion system 78 between a first mode in which the propulsion system 78 provides no power to the one or more ground engaging mechanisms 76 and a second mode in which the propulsion system 78 provides power to the one or more ground engaging mechanisms 76. This is an ON/OFF operation. In some implementations, the at least one additional signal causes the propulsion system 78 to provide power to the one or more ground engaging mechanisms 76 at a designated speed or change in speed. In some implementations, the at least one additional signal causes the propulsion system 78 to provide power to the one or more ground engaging mechanisms 76 at a designated torque or change in torque.

As shown in FIG. 8, in an example method 800, the control system 200 is usable to cause pivoting movement of the one or more ground engaging mechanisms 76. In the illustrative implementation, at a block 802, the controller 202 receives one or more first signals from the user interface 240, from one or more of the sensors 212, 214, 216, 218, 220, 222, 224, 226, 228, 230, 232, 233, 234, 235, 236, 238, 244 or by accessing the memory 208. For example, in some implementations, the one or more first signals is associated with a steering characteristic of the work machine 17 such as a position of the steering device 242 included in the user interface 240 (e.g., steering wheel, analog stick, touch-responsive input display) or an angle of the one or more work machine ground engaging mechanisms 13, 14 (e.g., as measured by the at least one angle sensor 216). At a block 804, the controller 202 sends at least one additional signal based on receipt of the one or more first signals. In the illustrative implementation, the controller 202 sends the at least one additional signal to the one or more pivot actuators 130, which, as shown at block 806, causes or enables the one or more pivot actuators 130 to pivot the one or more the ground engaging mechanisms (e.g., relative to the axial direction 113). In some implementations, the at least one additional signal switches the one or more pivot actuators 130 between a first mode in which the one or more pivot actuators 130 are not activated and a second mode in which the one or more pivot actuators 130 pivot the one or more ground engaging mechanisms 76. This is an ON/OFF operation. It should be appreciated that the exemplary methods described herein may be executed in conjunction with one another. For example, the example method 700 may be executed in connection with the example method 800 such that receipt (by the controller 202) of the one or more first signals may cause the controller 202 to: (i) send at least one additional signal to the propulsion system 78, which causes or enables the propulsion system 78 to change the propulsion of the cutting head 18 along the ground surface, and (ii) send at least one additional signal to the one or more pivot actuators 130, which causes or enables the one or more pivot actuators 130 to pivot the one or more the ground engaging mechanisms (e.g., relative to the axial direction 113).

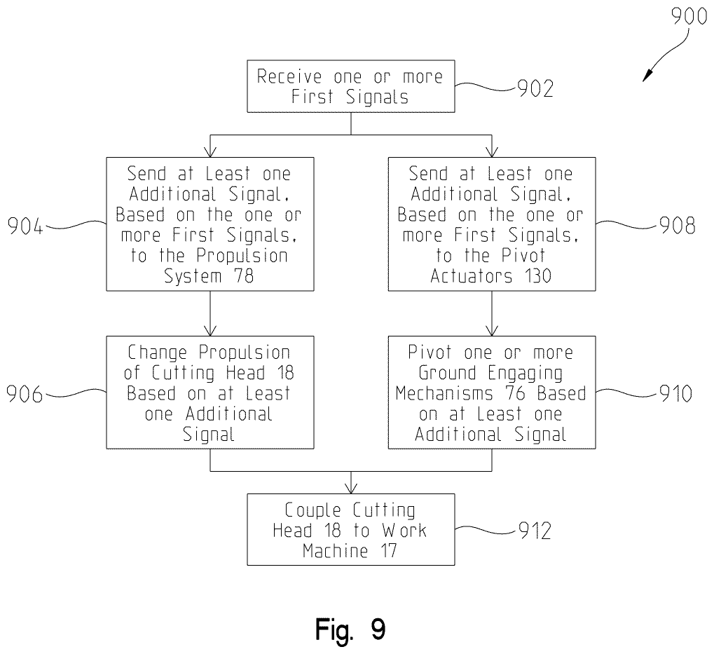

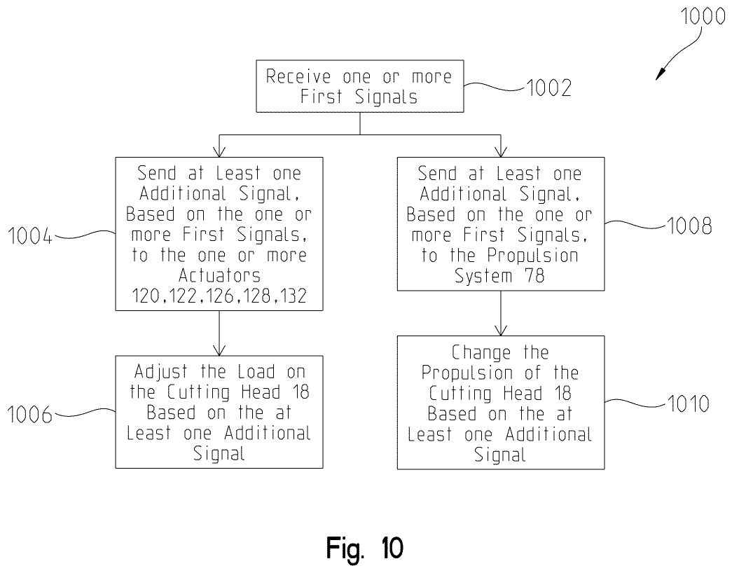

As shown in FIG. 9, in an example method 900, the control system 200 is usable to cause or enable action of the cutting head 18 associated with coupling the cutting head 18 to the work machine 17. In the illustrative implementation, at a block 902, the controller 202 receives one or more first signals from the user interface 240, from one or more of the sensors 212, 214, 216, 218, 220, 222, 224, 226, 228, 230, 232, 233, 234, 235, 236, 238, 244 or by accessing the memory 208. For example, in some implementations, the one or more first signals define a location to which the cutting head 18 is to be moved to couple with the work machine 17. In some implementations, the one or more first signals define a direction in which the cutting head 18 is to be moved to couple with the work machine 17. In some implementations, the direction in which the cutting head 18 is to be moved to couple with the work machine 17 includes at least one of an axial (i.e., forward or rearward) direction of movement and a lateral (i.e., right or left) direction of movement relative to the work machine 17. In some implementations, the direction in which the cutting head 18 is to be moved to couple with the work machine 17 includes a clockwise direction of movement or a counterclockwise direction of movement. In some implementations, the direction the cutting head 18 is to be moved or location to which the cutting head 18 is to be move to couple with the work machine 17 is based on at least one of the location and orientation of the work machine 17. In such implementations, the one or more first signals includes at least one of the location and orientation of the work machine 17.

At a block 904, the controller 202, based on receipt of the one or more first signals, sends at least one additional signal to the propulsion system 78. As shown at a block 906, the at least one additional signal sent from the controller 202 to the propulsion system 78 causes or enables the propulsion system 78 to change the propulsion of the cutting head 18 along the ground surface to facilitate coupling the cutting head 18 to the work machine 17. At a block 908, the controller 202, based on receipt of the one or more first signals, sends at least one additional signal to one or more pivot actuators 130. As shown at a block 910, the at least one additional signal sent from the controller 202 to the one or more pivot actuators 130 causes or enables the one or more pivot actuators 130 to pivot the one or more the ground engaging mechanisms 76 (e.g., relative to the axial direction 113) to facilitate coupling the cutting head 18 to the work machine 17. In some implementations, the one or more first signals of the block 904 may be the same as the one or more first signals of the block 908, and in the some implementations, the one or more first signals of the block 904 may be different than the one or more first signals of the block 908. The change in propulsion of the one or more ground engaging mechanisms 76, change in angle of the one or more ground engaging mechanisms 76, or both causes movement of the cutting head in a direction and orientation to align the cutting head 18 with the work machine 17. At a block 912, the cutting head 18 couples to the work machine 17, at the instruction of the controller 202.

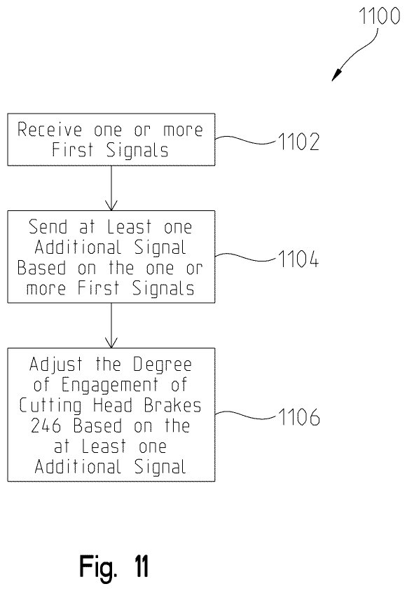

As shown in FIG. 10, in an example method 1000, the control system 200 is usable to cause or enable redistribution of a load on the cutting head 18. For example, in some implementations, the control system 200 causes redistribution of the load across the cutting head 18, and in some implementations, the control system 200 causes redistribution of the load between the cutting head 18 and the work machine 17. In the illustrative implementation, at a block 1002, the controller 202 receives one or more first signals from the user interface 240, from one or more of the sensors 212, 214, 216, 218, 220, 222, 224, 226, 228, 230, 232, 233, 234, 235, 236, 238, 244 or by accessing the memory 208. At the block 1004, based on the one or more first signals, the controller 202 sends at least one additional signal to at least one of the one or more actuators 120, 122, 126, 128, 132. As shown at a block 1006, the at least one additional signal causes or enables the one or more actuators 120, 122, 126, 128, 132 to adjust the load on cutting head 18. In some implementations, at a block 1008, based on the one or more first signals, the controller 202 sends at least one additional signal to the propulsion system 78. As shown at a block 1010, the at least one additional signal causes or enables the propulsion system 78 to change the power provided by the propulsion system 78 to the one or more ground engaging mechanisms 76. In some implementations, the one or more first signals of the block 1004 may be the same as the one or more first signals of the block 1008, and in some implementations, the one or more first signals of the block 1004 may be different than the one or more first signals of the block 1008.

In some implementations, to prevent or mitigate slip or for other reasons, it is advantageous to adjust the load on the cutting head 18 and the propulsion of the cutting head 18 simultaneously or in response to the same one or more first signals. In some implementations, the one or more first signals is an instruction to adjust a position of the cutting head 18 or a portion thereof, and in some implementations, the one or more first signals is an instruction to adjust a pressure associated with at least one actuator of the one or more actuators 120, 122, 126, 128, 132.

As shown in FIG. 11, in an example method 1100, the control system 200 is usable to cause engagement and disengagement of cutting head brakes 246, which when engaged cease or slow rotation of the ground engaging mechanisms 76. For example, at a block 1102, the controller 202 receives one or more first signals from the user interface 240, from one or more of the sensors 212, 214, 216, 218, 220, 222, 224, 226, 228, 230, 232, 233, 234, 235, 236, 238, 244 or by accessing the memory 208. In the illustrative implementation, the one or more first signals received at the block 1102 may also include an indication that a vehicle (e.g., the work machine 17) that is towing the cutting heading 18 is decelerating or accelerating at a rate different than the cutting head 18. For example, during a braking event of the vehicle towing the cutting head 18, a controller of the vehicle may send one or more signals to the controller 202 indicating that the vehicle towing the cutting heading 18 is decelerating. In another example, during deceleration of the vehicle towing the cutting heading 18 (or at another time), at least one contact sensor 244 is configured to measure a force or change in force applied by the vehicle towing the cutting head 18 to the cutting head 18, for example, during a deceleration event. In some implementations, the at least one contact sensor 244 is located on a hitch of the cutting head 18 or on another component of the cutting head 18 that couples the cutting head 18 to the vehicle towing the cutting head 18.

In the illustrative implementations, the cutting head brakes 246 may be coupled to the ground engaging mechanisms 76 directly or indirectly and prevent or mitigate rotation of the ground engaging mechanisms 76 when the cutting head brakes 246 are engaged. At the block 1104, the controller 202 sends at least one additional signal to the cutting head brakes 246, which as shown at a block 1106, adjusts the cutting head brakes 246 within a range of engagement modes including a fully engaged mode, a partially engaged mode (which includes a plurality of different degrees of engagement), and a disengaged mode.

In some implementations, the controller 202 sends the at least one additional signal to the cutting head brakes 246 causing the cutting head brakes 246 to move between: (i) a first position (e.g., in the fully engaged mode or the partially engaged mode), in which the cutting head brakes 246 contact a component that is configured to rotate to provide power to the one or more ground engaging mechanisms 76, and (ii) second position (e.g., in the disengaged mode), in which the cutting head brakes do not contact the component. In such implementations, when the cutting head brakes 246 are in the first position, rotation of the one or more ground engaging mechanism 76 ceases or slows.

In some implementations, the controller 202 sends the at least one additional signal to the cutting head brakes 246, which causes a change in an electrical current associated with a degree of engagement of the cutting head brakes 246. In some implementations, the controller 202 send the at least one additional signal to the cutting head brakes 246, which causes movement of one or more valves to adjust a pressure associated with the degree of engagement of the cutting head brakes 246. In some implementations, the cutting head brakes includes a manually operable actuator (e.g., a pivotable or slidable lever, compressible button, or inserted pin), which when engaged, prevents or mitigates rotation of the one or more ground engaging mechanisms 76.

While the disclosure has been illustrated and described in detail in the drawings and foregoing description, such illustration and description is to be considered as exemplary and not restrictive in character, it being understood that illustrative implementation(s) have been shown and described and that all changes and modifications that come within the spirit of the disclosure are desired to be protected. It will be noted that alternative implementations of the present disclosure may not include all of the features described yet still benefit from at least some of the advantages of such features. Those of ordinary skill in the art may readily devise their own implementations that incorporate one or more of the features of the present disclosure and fall within the spirit and scope of the present disclosure as defined by the appended claims.

1. An agricultural machine for harvesting crop, comprising:
a cutting head configured to harvest crop and conduct harvested crop to a work machine configured to process harvested crop, the cutting head including one or more ground engaging mechanisms configured to rotate to propel the cutting head along a ground surface;
a propulsion system configured to provide power to the one or more ground engaging mechanisms to drive rotation thereof; and
a controller configured to receive one or more first signals and send at least one additional signal based on receipt of the one or more first signals; and
wherein the at least one additional signal causes redistribution of a load on the cutting head.

2. The agricultural machine of claim 1, wherein the one or more additional signals further causes adjustment of the power provided by the propulsion system to the one or more ground engaging mechanisms.

3. The agricultural machine of claim 1, further comprising one or more actuators that are operatively coupled to the controller and configured to extend or retract based on the at least one additional signal to redistribute the load on the cutting head.

4. The agricultural machine of claim 3, wherein the at least one additional signal is a command from the user interface to adjust a pressure within at least one actuator of the one or more actuators.

5. The agricultural machine of claim 3, wherein the at least one additional signal is a command from the user interface to adjust a position of the cutting head or a portion thereof.

6. The agricultural machine of claim 3, wherein the work machine further comprises a feederhouse coupled to and configured to receive harvested crop from the cutting head; and
wherein the one or more actuators are configured to move the feederhouse based on the at least one additional signal.

7. The agricultural machine of claim 3, wherein the cutting head includes: (i) an attachment frame and (ii) a body frame to which the one or more ground engaging mechanisms are coupled; and
wherein the one or more actuators is configured to extend and retract to move the body frame relative to the attachment frame based on the at least one additional signal.

8. The agricultural machine of claim 3, wherein the cutting head includes a center frame and first wing coupled to a first side of the center frame; and
wherein the one or more actuators is configured to extend and retract to move the first wing relative to the center frame based on the at least one additional signal.

9. The agricultural machine of claim 3, wherein the cutting head further includes a body section coupled to the one or more ground engaging mechanisms;
wherein the body section is configured conduct harvested crop to the work machine; and
wherein the one or more actuators is configured to extend and retract to move the body section relative to the one or more ground engaging mechanisms based on the at least one additional signal.

10. The agricultural machine of claim 1, wherein the one or more first signals is indicative of a load on the cutting head.

11. The agricultural machine of claim 1, wherein the one or more first signals is indicative of a load on the work machine.

12. The agricultural machine of claim 1, wherein one or more first signals is indicative of a load on at least one of:
the cutting head at a specified location on the cutting head; and
the work machine at a specified location on the work machine.

13. The agricultural machine of claim 1, wherein the one or more first signals is indicative of a future load on at least one of the cutting head and the work machine.

14. The agricultural machine of claim 1, wherein the one or more first signals is associated with a soil condition of a work site of the agricultural machine; and
wherein the soil condition of the worksite includes at least one of soil moisture, soil type, soil firmness, and soil adhesion.

15. The agricultural machine of claim 1, wherein the one or more first signals is associated with a terrain of a work site of the agricultural machine; and
wherein the terrain of the worksite includes at least one of pitch and roll of the worksite.

16. The agricultural machine of claim 1, further comprising the work machine;
wherein the work machine is a combine configured to thresh harvested crop received from the cutting head.

17. The agricultural machine of claim 1, wherein the one or more first signals is indicative of at least one of:
slip of one or more ground engaging mechanisms of the cutting head; and
slip of one or more work machine ground engaging mechanisms.

18. The agricultural machine of claim 17, wherein the one or more first signals is associated with at least one of: a speed of the work machine, a speed of the cutting head, a speed of one or more work machine ground engaging mechanisms, and a speed of the one or more ground engaging mechanisms of the cutting head.

19. An agricultural machine for harvesting crop, comprising:
a cutting head configured to harvest crop and conduct harvested crop to a work machine configured to process harvested crop, the cutting head including one or more ground engaging mechanisms configured to rotate to propel the cutting head along a ground surface;
one or more actuators configured to redistribute a load on the cutting head; and
a propulsion system configured to adjust power provided to the one or more ground engaging mechanisms based on redistribution of load on the cutting head.

20. A method of propelling a cutting head for harvesting crop, comprising:
providing power, via a propulsion system, to one or more ground engaging mechanisms of the cutting head to drive rotation of the one or more ground engaging mechanisms and propel the cutting head along a ground surface;
receiving one or more first signals via a controller; and
sending at least one additional signal, via the controller, to one or more actuators based on receipt of the one or more first signals, wherein the at least one additional signal causes redistribution of load on the cutting head.
